(19) United States
(12) Patent Application Publication
(10) Pub. No.: US 2014/0187312 A1
(43) Pub. Date: Jul. 3, 2014

(54) SYSTEM AND METHOD FOR QUICK RESTART OF A GAME ON AN AMUSEMENT DEVICE

(71) Applicant: Megatouch, LLC, Bristol, PA (US)

(72) Inventor: William L. LAYNE, IV, Harleysville, PA (US)

(73) Assignee: Megatouch, LLC, Bristol, PA (US)

(21) Appl. No.: 14/145,314

(22) Filed: Dec. 31, 2013

Related U.S. Application Data
(60) Provisional application No. 61/748,265, filed on Jan. 2, 2013.

(51) Int. Cl. A63F 13/40

(52) U.S. Cl. CPC A63F 13/10
USPC 463/24

(57) ABSTRACT

A method for directing game play of a game having a game start and a game end on an amusement device. The amusement device includes a controller, a memory, a display and an input device. The method includes directing the amusement device to display the game to a user on the display; receiving, from the input device and at the controller, a signal to quit the game prior to the game end; sending a signal from the controller to the display to present a restart graphical user interface; and receiving, from the input device and at the controller, a signal to restart the game and immediately configuring the amusement device to the game start through the controller.

### CROSS-REFERENCE TO RELATED APPLICATIONS

This application claims the benefit of U.S. Provisional Patent Application No. 61/748,265, filed on Jan. 2, 2013, entitled “System and Method for Quick Start of a Game on an Amusement Device,” the entire contents of which are incorporated herein by reference in their entirety.

### BACKGROUND OF THE INVENTION

Competitive amusement game players often play amusement games to achieve a specific goal or objective. The objective or goal may be to get the best score possible, but there are numerous additional objectives a player may target or attempt to achieve during game play.

In certain gaming systems, a game may be presented to a player with a specific objective, which may be a non-score objective or a score objective, and the player is rewarded when they meet the objective. For example, a “Make 10 shots in a row” objective or a “Find 5 differences in fewer than 5 seconds” objective may be presented to the player and the player is rewarded when the objective is attained during game play. Players may even set a goal for themselves or with friends so the objectives and goals may not be defined, tracked or recorded by the game/system, as certain objectives and goals are defined, tracked and/or recorded by the players themselves. Players may also compete in a tournament event that could have many and various player goals outside of “get the best score” or like objectives.

In all the above cases, the player may realize that they cannot attain their intended objective before the game is finished or ends. They may not have enough time left to complete a round resulting in missing a scoring bonus, have already made an error in game play where they had to perform perfectly or they simply failed to perform well enough and know by the game rules their goal cannot be achieved or attained. This can happen many times in high score chasing or in tournament-style play where a high level of play is required to place well on the leader boards. Such a player is generally not playing for fun. When the player knows they will not attain the objective or are having a bad game, they may want to quit the game immediately instead of playing through the remainder of the game. Playing through the remainder of the game often takes time that the player is not willing to use on a game that they perceive as already being lost. Such game play is wasted effort in the perception of such a player and there is no point to such game play to the player, since they know they can't attain their objective. Such a player may want to start a new game as quickly as possible to try again from the start or beginning of the game to achieve their goal or objective.

In typical gaming systems, quitting the game prior to its natural ending results in scrolling through a variety of menus/screens. These menus/screens can delay the restart of the game, thereby wasting additional time of the player while that player is admitted back into the game. The game menus/screens may include game performance summary screens, name entry screens, promotion screens, start-up screens, game selection menus and other like screens or menus. The player may also have to interact with the menu/system that allowed them to start the game. All of these additional menus/screens intrude with the player's goal of restarting the game as soon as possible. For example, the player will typically not want to enter their name into the HI scores lists if they purposefully quit the game during the middle of game play to start the game over from the beginning so that they can again chase a specific goal or objective that they were unable to achieve during play of the immediately preceding game.

Players who are pursuing a particular objective during game play often find the number of screens the player has to interact with and the number of steps they have to take to restart a game undesirable in delaying their entry back into the start of the game or to another preferred portion of the game.

The present system and method for quick restart of a game on an amusement device addresses the above-described shortcomings of existing gaming systems and methods.

### BRIEF SUMMARY OF THE INVENTION

Briefly stated, a preferred embodiment of the present invention is directed to a system and method for directing game play of a game. The game has a game start and a game end. The game is preferably played on an amusement device. The game play may be moved directly from the middle of game play, immediately to the game start upon the prompting of the user. The amusement device includes a controller, a memory, a display and an input device. The method includes directing the amusement device to display the game to a user on the display; receiving, from the input device and at the controller, a signal to quit the game prior to the game end; sending a signal from the controller to the display to present a restart graphical user interface; and receiving, from the input device and at the controller, a signal to restart the game and immediately configuring the amusement device to the game start.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the preferred invention, there are shown in the drawings embodiments which are presently preferred. It should be understood, however, that the preferred invention is not limited to the precise arrangements and instrumentalities shown. In the drawings:

FIG. 1A is a front perspective view of an amusement device in accordance with a first preferred embodiment of the present invention;

FIG. 1B is a front perspective view of an amusement device in accordance with a second preferred embodiment of the present invention;

FIG. 1C is a front perspective view of an amusement device in accordance with a third preferred embodiment of the present invention;

FIG. 2 is a schematic block diagram of an amusement system including a currency input in accordance with preferred embodiments of the present invention that may incorporate any of the preferred amusement devices of FIGS. 1A-1C; and

FIG. 3 is a view of a preferred restart graphical user interface presented on a display of the preferred amusement devices of FIGS. 1A-1C.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one.” The words “right,” “left,” “lower,” and “upper” designate directions in the drawings to which reference is made. The words “inwardly” or “distally” and “outwardly” or “proximally” refer to directions toward and away from, respectively, the geometric center or orientation of the device and related parts thereof. The terminology includes the above-listed words, derivatives thereof and words of similar import.

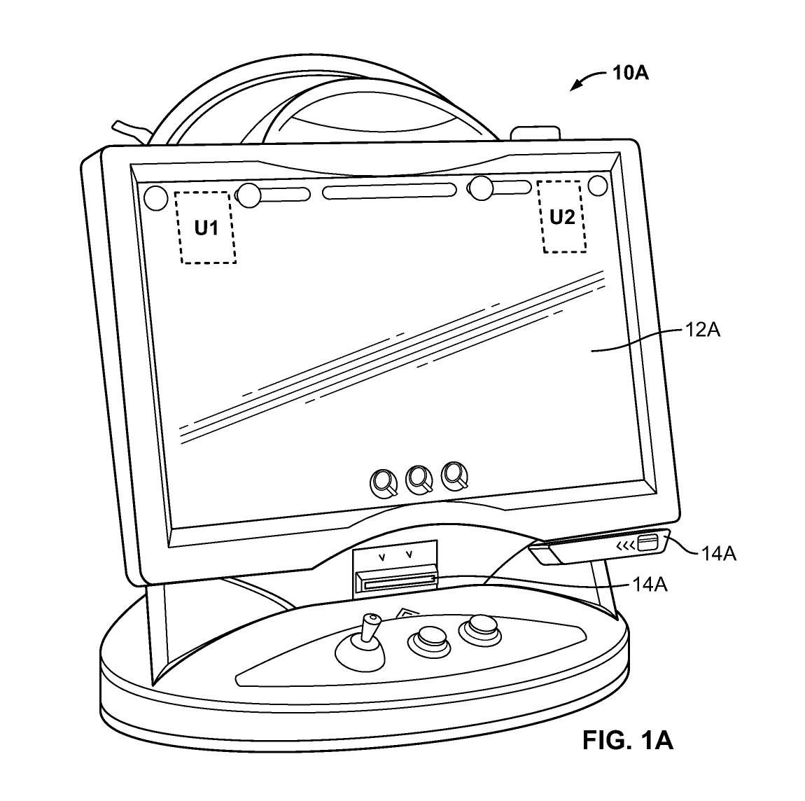

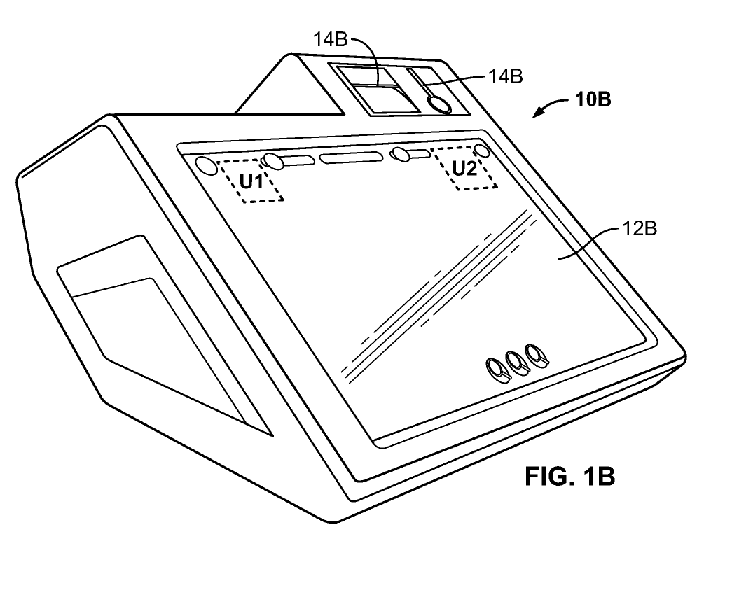

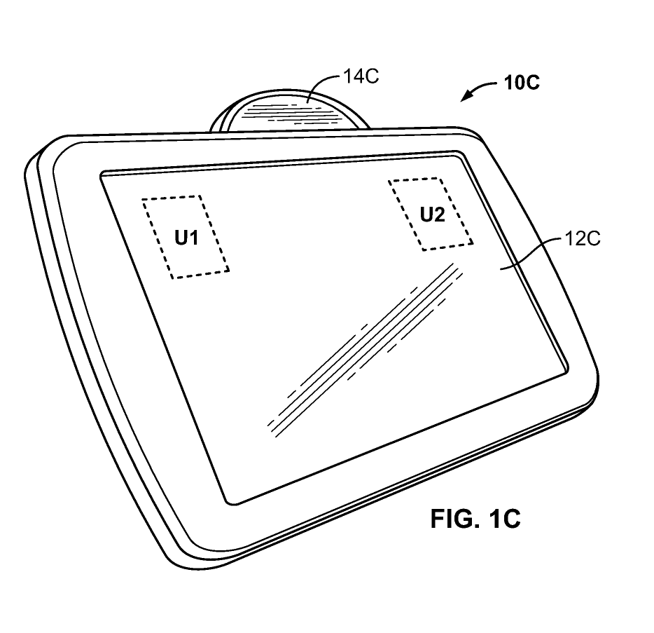

Referring to the drawings in detail, wherein like reference numerals indicate like elements throughout, there is shown in FIG. 1A a first preferred embodiment of an amusement device 10A. The amusement device 10A includes a controller U1 and a memory U2. The memory U2 can be any known or suitable memory device such as random access memory (RAM), read only memory (ROM), flash RAM, hard disk, optical disk, or the like. The amusement device 10A further includes a video display 12A that is operatively connected to the controller U1. The amusement device 10A is preferably a counter-top or table-top apparatus, but may be arranged in any configuration, such as free-standing, floor-standing, table mount, wall mount, pole mount, and the like without departing from the invention.

The amusement device 10A also includes at least one currency input component 14A that receives value in order to establish one or more playable credits. The value received may be at least one of currency, coins, tokens, chits, credits, credit cards/debit cards or the like. Although two currency input components 14A are shown, the amusement device 10A may include any number of currency input components 14A to give the user or player an option for payment, for permitting multiple players, or the like. Preferably, the amusement device 10A is made operable upon actuation of the currency input component 14A, for example, the user may only select and play an electronic game once value is received at the currency input component 14A and/or one or more playable credits are issued to the user. However, free selections may be offered at the discretion of an operator of the amusement device 10A. The electronic game preferably has a minimum currency value that must be input into the currency input component 14A before the game will begin play or prompt the user or player to select a particular game for game play, wherein the game has a game start and a game end.

FIG. 1B shows another or second amusement device 10B in accordance with a second preferred embodiment of the present invention. The second amusement device 10B also includes a controller U1, a memory U2, a video display 12B, and at least one currency input component 14B. Preferably, the video displays 12A, 12B are touchscreen video displays configured to accept touch input, but are not so limited. The touchscreen video displays 12A, 12B of the first and second preferred embodiments comprise input portions 12A, 12B that are in communication with the controller U1 to provide interaction between the user and the amusement device 10A, 10B and are used to direct the game play. The amusement devices 10A, 10B are not limited to touchscreen video displays 12A, 12B for their input portions 12A, 12B, which may comprise keyboards, mice, trackballs, wands or other input devices that permit signaling from the user to the controller U1 or the amusement device 10A, 10B.

FIG. 1C shows yet another or third amusement device 10C in accordance with a third preferred embodiment of the present invention. The third amusement device 10C is preferably a portable device, preferably battery-powered, and includes a controller U1, memory U2, a display 12C, and at least one currency input component 14C. The third amusement device 10C is preferably usable with a docking station (not shown). The docking station preferably secures the amusement device 10C until access is required by an operator or is paid for by a user. In this configuration, the user or player preferably must input a minimum undocking currency amount at the currency input component 14C to release the third amusement device 10C from the docking station. Release from the docking station may occur via an entry through the currency input component 14C, which is preferably a card reader. The docking station may also provide battery recharging and other services to the amusement device 10C.

For convenience, the amusement devices 10A, 10B, 10C will be referred to hereinafter simply as “amusement device 10,” the displays 12A, 12B, 12C will be referred to hereinafter simply as “display 12,” and the currency input components 14A, 14B, 14C will be referred to hereinafter simply as “currency input component 14.”

Turning now to the operation of the amusement device 10, the memory U2 preferably stores one or more application programs, such as electronic games, a music or video jukebox program, or the like, and a system control program. However, the one or more application programs may also be stored remotely. The controller U1 controls the touchscreen display 12 based upon the system control program retrieved from the memory U2 and based upon inputs from the touchscreen display 12 or other input portions, such as keyboards, trackballs, mice or related input devices or hardware. As used herein, the system control program refers to all of the software functions outside of the application program files including an operating system, device profile, display control, input control, sound drivers, and the like. Other input portions, in addition or alternatively to the touchscreen display 12, that may be connected to the amusement device 10 include a pushbutton(s), a trackball or touchpad, a mouse, a joy-stick, a foot-pedal, a voice recognition system, a keypad or keyboard, and the like. But, preferably, the input portion is comprised of the touchscreen display 12.

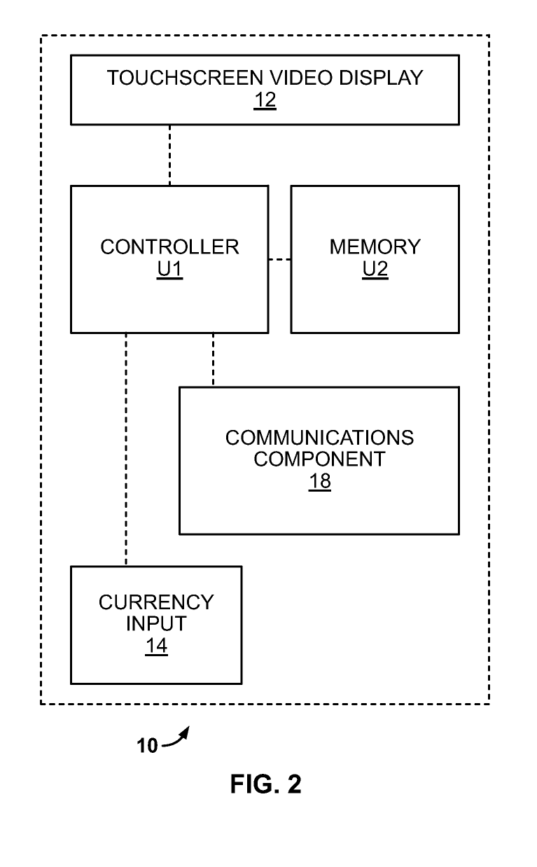

FIG. 2 is a schematic block diagram of the preferred amusement device 10. The touchscreen display 12 is coupled to the controller U1. Also coupled to the controller U1 is the currency input component 14. The currency input component 14 may accept at least one of coins (or tokens), currency (e.g. paper money or the like), credit cards/debit cards, and the like. Although only one currency input component 14 is shown, the amusement device 10 may include more than one currency input component 14 to give a user an option for payment, for permitting multiple players, or the like. Preferably, the amusement device 10 is made operable upon payment by a user of the minimum currency value, which may optionally be received via the currency input component 14.

The amusement device 10 also preferably includes a communications component 18, such as an Ethernet port, a wireless transceiver, an infrared (IR) port, or the like. Using the communications component 18, the amusement device 10 may communicate with other devices or file servers, access the Internet, communicate over wide area networks (WANs) or local area networks (LANs), or the like. For example, the amusement device 10 may connect with a second amusement device (not shown) using the communications component 18. The second amusement device optionally includes all of the same components and features as the amusement device 10. The communications component 18 is connected to the controller U1 and through the controller U1 to the memory U2. The amusement device 10 preferably includes an operating mode and a setup mode. To switch from the operating mode to the setup mode, when an operator is present at the amusement device 10, a mode selector pushbutton (hardware not shown) is provided that is typically concealed from the users. The mode selector pushbutton may be implemented as a hidden software feature, but preferably the mode selector pushbutton is a simple pushbutton that is disposed inside a housing of the amusement device 10. When the operating mode is selected, a player or user is selectively permitted to access the application programs. When the setup mode is selected, the owner/operator is permitted to make system setup adjustments.

Each amusement device 10 has a plurality of system configuration settings that may be adjusted to alter the operation or appearance of the amusement device 10. The configuration settings are set by an owner/operator based on factors such as the local laws, business needs and judgment of the amusement device 10 owner/operator. The configuration settings of each amusement device 10 may be set independently of one another. However, where an owner/operator controls a large number of amusement devices 10, it is preferable to quickly and easily configure a plurality of amusement devices 10 with common configuration settings. For example, an owner/operator may want all amusement devices 10 deployed at bars to have a first common configuration and all amusement devices 10 deployed at family restaurants to have a second common configuration. In accordance with the present invention, an operator account is maintained for each owner/operator at a central location accessible over a network. The owner/operator may configure one or more configuration settings profiles in the operator account and assign amusement devices 10 to the one or more settings profiles. The configuration settings are then automatically managed for all assigned amusement devices 10 by the central location.

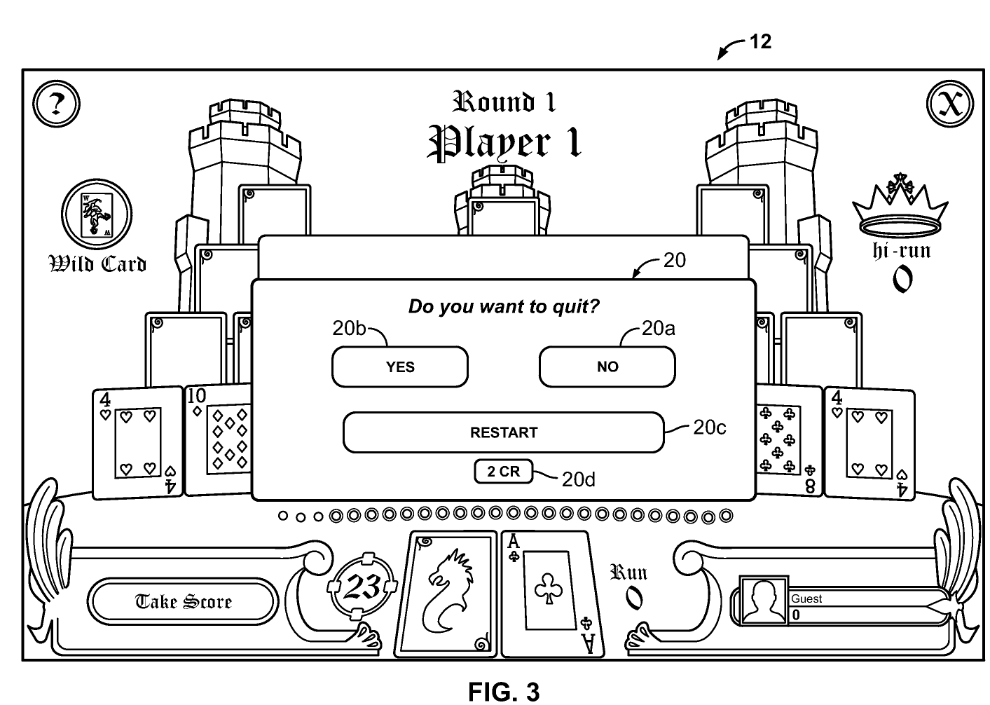

Referring to FIGS. 1-3, the preferred amusement device 10 allows players to send a signal to the controller U1 that they intend to quit the current game, which is proceeding through game play, but is not at its natural game end, and restart the game from the beginning. The preferred amusement device 10 offers a restart graphical user interface (“GUI”) 20 to the user when the user sends a signal to the controller U1 that they want to quit the game in the middle of game play or prior to the typical game end. The restart GUI 20 is preferably comprised of a pop-up prompt that appears when a player elects to quit a game in the middle of the game or when the game is not at a natural game end, such as during a lap of a race where the game would typically not end until the user's vehicle crosses the finish line. The restart GUI 20 preferably provides a prompt to the user asking whether the user wants to quit the game, such that the user may re-enter the game by selecting a no indicator 20a, which if selected will move the user back into the same portion of the game that is currently being played, quits the game if the user selects a yes indicator 20b, which stops or quits the game and also provides a “restart” option or restart indicator 20c, which if selected immediately prompts or signals the controller 18 to restart the game at the game start. When the restart indicator 20c is selected the player is indicating to the controller U1 they want to restart the current game without needing to deal with all the menus, screens, windows or prompts that typically appear at the end of a game or when the game is initially started from scratch. This allows the user or player to start the game nearly instantly from the game start so that the user is able to continue to pursue their goal or objective for the game.

In the preferred system, the restart indicator 20c preferably takes care of all the accounting requirements of ensuring there are enough credits to continue game play, thereby allowing players to add more credits to continue playing the game by cash or credit card, preferably through the currency input component 14. The controller U1 also preferably is able to determine if the user or player has enough credits loaded into the amusement device 10 such that the game may be started substantially immediately from the game start, without requiring the user or player to scroll through menus, screens, windows or prompts that typically appear when a game is initially started. Selecting the restart indicator 20c preferably instantly exits the game, shutting down the game's executable and then restarting it right away if all the credit requirement checks pass. Likewise, if all of the credit requirement checks do not pass, the user is preferably prompted by a graphical user interface to insert or provide additional currency and, when sufficient currency is provided, the controller U1, preferably instantly, restarts the game at the game start.

The restart indicator 20c, through the controller U1, also preferably accounts for multiplayer games, ensuring each player is charged the correct amount of credits. A credit requirements indicator 20d is preferably displayed below the restart indicator 20c on the restart GUI 20 and presents the number of credits required or amount of currency required to restart the game so that the user is aware how much currency and/or credits are required to take the requested action. While the preferred controller U1, upon selection of the restart indicator 20c, handles all this accounting, such accounting is not required and the preferred system and method will function without the currency and credit calculation from the controller U1. The same concept applies in Freeplay or on a non-coin-op system.

In the preferred embodiment, the signal from the restart indicator 20c that the user desires to restart the game results in the controller U1 restarting the game from the beginning or game start. Such a restart is preferably a restart from the very beginning of the game without requiring the user or player to scroll through menus, screens, windows or prompts that typically appear when a game is initially started. Any selections made by the user or player in their first scroll through the menus, screens, windows or prompts typically appearing at the initial game start are preferably saved by the controller U1 and automatically re-applied when the user or player selects the restart indicator 20c. For example, the user or player may be prompted to select a background for the display 12 that is used during game play during the initial game start and such selection of background for the display 12 will be saved and re-applied for the subsequent game when the user selects the restart indicator 20c. In addition, the user or player may be prompted to select the number of players participating in the particular game during the initial game start and such selection of the number of players for the game will be saved and re-applied by the controller U1 for the subsequent game when the user selects the restart indicator 20c. In the preferred embodiment, the player can restart the present game at any time during the game, not only at specific points, and the restart GUI 20 permits the user or player to quit the game completely, rejoin game play at the same point that they temporarily left the game or restart the game from the beginning. In addition, after the game is restarted, either at the game start or at the same point that they temporarily left the game, the user may again communicate with the amusement device 10 to prompt the restart GUI 20 and make a selection to not quit the game, by impacting the no indicator 20a, and continue the game from the previous portion, to quit the game, by impacting the yet indicator 20b, and quitting the game or make a selection to restart the game, by impacting the restart indicator 20c.

In the preferred embodiment, the preferred amusement device 10 is able to perform a method for directing game play of a game, having a game start and a game end. The method includes directing the amusement device 10 to display or present the game to the user on the display 12. The game is preferably presented on the preferred touchscreen display 12 such that the user is able to view and interact with the game through the touchscreen display 12. The user preferably plays the game and may come to a point in the game where they realize they will be unable to reach and objective or goal. The user may then elect to indicate to the amusement device 10 that they intend to quit the game. The user may indicate that they intend to quit the game to the amusement device 10 in various manners, such as by selecting a specific restart or quit location on the touchscreen display 12, depressing a restart or quit button on the amusement device 10, electing a specific series of keystrokes or motions on hardware associated with the amusement device 10 or any other number of manners to alert the controller U1 that the user or player intends to quit or restart the game. The controller U1 preferably receives the signal from the user that they intend to quit or restart the game and the preferred amusement device 10 preferably presents the restart GUI 20. The controller U1 preferably prompts the restart GUI 20 when the user signals to the controller U1 that they intend to quit the game before its natural or expected game end. The restart GUI 20 of the preferred embodiment prompts the user to confirm that they intend to completely quit the game by selecting the yes indicator 20b, indicate that they do not want to quit the game and that they want to re-enter the game by selecting the no indicator 20a or indicate that they want to restart the game from the game start by selecting the restart indicator 20c. Selection of the restart indicator 20c results in a signal being sent to and received by the controller U1 to restart the game. Upon receipt of the restart signal, the controller 18 immediately configures the amusement device 10 to the game start, preferably by actually shutting down the game's executable and then restarting the game from the beginning. The game is preferably restarted at the beginning of the game without requiring the user to scroll through the menus, screens, windows or prompts that typically appear at the end of a game or when the game is initially started from scratch.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the disclosure herein.

We claim:

1. A method for directing game play of a game having a game start and a game end on an amusement device, wherein the amusement device includes a controller, a memory, a display and an input device, the method comprising:
a) directing the amusement device to display the game to a user on the display;
b) receiving, from the input device and at the controller, a signal to quit the game prior to the game end;
c) sending a signal from the controller to the display to present a restart graphical user interface;
d) receiving, from the input device and at the controller, a signal to restart the game; and
e) immediately configuring the amusement device to the game start through the controller.

2. The method of claim 1, wherein the signal received in step (b) is from the input device and the input device is comprised of a touchscreen video display.

3. The method of claim 1, wherein the restart graphical user interface includes a prompt related to whether a user wants to quit the game.

4. The method of claim 1, wherein the restart graphical user interface includes an restart option.

5. The method of claim 1, wherein the signal received in step (b) results from the player selecting a restart location on the input device, the input device comprised of a touchscreen display.

6. The method of claim 1, wherein the restart graphical user interface of step (c) includes a no indicator, a yes indicator, a restart indicator and a credits requirements indicator that are displayed on the display, the display comprising a touchscreen display and the touchscreen display comprising the input device.

7. The method of claim 6, further comprising:
f) receiving, from the input device and at the controller, a second signal to quit the game prior to the game end after step (e);
g) displaying, on the display, the restart graphical user interface; and
h) receiving, from the input device and at the controller, a yes signal to quit the game prior to the game end when the yes indicator is impacted, the input device comprised of the display and the display comprised of a touchscreen display.

8. The method of claim 6, further comprising:
f) receiving, from the input device and at the controller, a second signal to quit the game prior to the game end after step (e);
g) displaying, on the display, the restart graphical user interface;
h) receiving, from the input device and at the controller, a no signal when the no indicator is impacted, the input device comprising the display and the display comprising a touchscreen display; and
i) immediately configuring the amusement device, through the controller, to continue game play of the game at the portion of the game being played immediately prior to step (f).

9. The method of claim 6, wherein the signal received in step (d) results from the restart indicator being impacted, the input device comprising the display and the display comprising a touchscreen display.

10. The method of claim 1, further comprising:
f) conducting a credit requirement check, with the controller, prior to step (e).

11. The method of claim 10, further comprising:
g) determining, with the controller, that there is insufficient currency to restart the game; and
h) displaying, on the display, a currency request graphical user interface requesting the provision of additional currency to the amusement device.

12. A method for directing game play of a game having a game start and a game end on an amusement device, wherein the amusement device includes a controller, a memory and a touchscreen display, the method comprising:
a) directing the amusement device to display the game to a user on the display;
b) receiving, from the touchscreen display and at the controller, a signal to quit the game prior to the game end;
c) sending a signal from the controller to the display to present a restart graphical user interface, the graphical user interface including a yes indicator, a no indicator and a restart indicator;
d) receiving, from the touchscreen display and at the controller, a signal to restart the game when the restart indicator is impacted on the touchscreen display; and
e) immediately configuring the amusement device to the game start through the controller.

13. The method of claim 12, wherein the signal received in step (b) results from an impact to the touchscreen display.

14. The method of claim 12, wherein the signal received in step (b) results from an impact to a quit location on the touchscreen display.

15. The method of claim 12, further comprising:
f) receiving, from the touchscreen display and at the controller, a second signal to quit the game prior to the game end after step (e);
g) displaying, on the touchscreen display, the restart graphical user interface;
h) receiving, from the touchscreen display and at the controller, a yes signal to quit the game prior to the game end when the yes indicator is impacted; and
i) immediately configuring the amusement device to quit the game.

16. The method of claim 12, further comprising:
f) receiving, from the touchscreen display and at the controller, a second signal to quit the game prior to the game end after step (e);
g) displaying, on the touchscreen display, the restart graphical user interface;
h) receiving, from the touchscreen display and at the controller, a no signal when the no indicator is impacted; and
i) immediately configuring the amusement device, through the controller, to continue game play of the game at the portion of the game being played immediately prior to step (f).

17. A method for directing game play of a game having a game start and a game end on an amusement device, wherein the amusement device includes a controller, a memory and a touchscreen display, the method comprising:
a) directing the amusement device to display the game to a user on the display;
b) receiving, from the touchscreen display and at the controller, a signal to quit the game prior to the game end when a quit location is impacted on the touchscreen display; and
c) sending a signal from the controller to the display to present a restart graphical user interface, the restart graphical user interface including a yes indicator, a no indicator and a restart indicator.

18. The method of claim 17, further comprising:
d) receiving, from the touchscreen display and at the controller, a signal to restart the game when the restart indicator is impacted on the touchscreen display; and
e) immediately configuring the amusement device to the game start through the controller.

19. The method of claim 17, further comprising:
d) receiving, from the touchscreen display and at the controller, a yes signal to quit the game when the yes indicator is impacted on the touchscreen display; and
e) immediately configuring the amusement device to quit the game through the controller.

20. The method of claim 17, further comprising:
d) receiving, from the touchscreen display and at the controller, a no signal not to quit the game when the no indicator is impacted on the touchscreen display; and
e) immediately configuring the amusement device to continue play of the game through the controller at the portion of the game being played prior to step (b).
